(19) United States
(12) Patent Application Publication
(10) Pub. No.: US 2022/0119965 A1
(43) Pub. Date: Apr. 21, 2022

(54) Nanoparticle-Ligand Composite Catalyst Including a Pseudocapacitive Interface for Carbon Dioxide Electrolysis

(71) Applicant: The Regents of the University of California, Oakland, CA (US)

(72) Inventors: Peidong Yang, Kensington, CA (US); Dohyung Kim, Sunnyvale, CA (US); Sunmoon Yu, Albany, CA (US)

(21) Appl. No.: 17/498,260

(22) Filed: Oct. 11, 2021

Related U.S. Application Data
(60) Provisional application No. 63/091,999, filed on Oct. 15, 2020.

(51) Int. Cl. C25B 11/042; C25B 1/23; C25B 11/037; C25B 11/052; C25B 11/065; C25B 11/061; C25B 3/07; C25B 3/03

(52) U.S. Cl. CPC C25B 11/042; C25B 1/23; C25B 11/037; C25B 3/03; C25B 11/065; C25B 11/061; C25B 3/07; C25B 11/052

(57) ABSTRACT

This disclosure provides systems, methods, and apparatus related to nanoparticle/ordered-ligand interlayers. In one aspect, a structure comprises an assembly and a layer of ligands disposed on a surface of the assembly. The assembly comprises a plurality of metal nanoparticles. The metal nanoparticles of the plurality of metal nanoparticles in the assembly are proximate one another. The layer of ligands is operable to detach from the surface of the assembly but to remain proximate the surface of the assembly when the assembly is disposed in an electrolyte and a negative bias is applied to the assembly. An interlayer forms between the assembly and the layer of ligands, with the interlayer comprising desolvated cations from the electrolyte.

### RELATED APPLICATIONS

This application claims priority to U.S. Provisional Patent Application No. 63/091,999, filed Oct. 15, 2020, which is herein incorporated by reference.

### STATEMENT OF GOVERNMENT SUPPORT

This invention was made with government support under Contract No. DE-AC02-05CH11231 awarded by the U.S. Department of Energy. The government has certain rights in this invention.

### TECHNICAL FIELD

This disclosure relates generally to catalysts and more particularly catalysts for carbon dioxide electrolysis.

### BACKGROUND

Enzymes achieve superior catalytic specificity and turnover by creating optimal nanoscale environments around active sites using amino acid side chains, in which molecular recognition and subsequent catalysis are synergistically conducted. The two-electron conversion of CO₂ to CO/formate with a minimal energy barrier exemplifies the ideal catalytic reactivity of enzymes. In order to develop catalytic machineries for enzyme mimicry, synthetic nanoparticles (NPs) with surface ligands containing moieties that interact with active sites and/or reactant intermediates have been developed. However, creating such ideal catalysts requires the precise configuration of multiple functional groups and mobile parts that dynamically respond to external stimuli, the manipulation of which is limited in present strategies that are restricted to ligands in a tethered configuration. Moreover, such efforts for electrocatalysis should further consider any possible interactions between the catalyst and components of an electrochemical interface (that is, electrolyte ions and solvent molecules), which have been largely overlooked thus far. Therefore, a synthetic electrocatalyst functioning through cooperatively combining all of the above aspects has yet to be developed.

### BRIEF DESCRIPTION OF THE DRAWINGS

Details of one or more embodiments of the subject matter described in this specification are set forth in the accompanying drawings and the description below. Other features, aspects, and advantages will become apparent from the description, the drawings, and the claims. Note that the relative dimensions of the following figures may not be drawn to scale.

FIG. 1 shows a schematic diagram of the formation of a NOLI and a metal-NOLI catalyst for selective electrocatalysis. Chains on the metal NPs represent chemically bonded alkylphosphonic ligands. Upon applying a negative bias on the assembled NPs, the ligands collectively dissociate from the metal surface during NP fusion and transition to a reversible physisorption state (explicitly shown by the emphasized phosphonate head group). Vₚₒₛ and V_{neg} indicate a positive (anodic) and a negative (cathodic) polarization of the metal particles, respectively. The ligand layer maintains its stability through the non-covalent interactions of the alkyl tails in an ordered configuration (indicated by the double-headed arrows). The resultant metal-NOLI catalyst provides a unique catalytic pocket for selective CO₂ electroconversion.

FIGS. 2A-2D show the results of characterization of NOLI formed by the collective dissociation of ligands from an assembly of NPs. FIG. 2A shows scanning electron microscopy images of Ag-NOLI (scale bar, 200 nanometers (nm)) and assembled Ag NPs (inset; scale bar, 25 nm). FIG. 2B shows initial linear sweep voltammetry of assembled Ag NPs. Inset shows a cartoon of the H-cell configuration used for all the electrochemical testings (WE, working electrode; RE, reference electrode; CE, counter electrode; GC, gas chromatograph). FIGS. 2C and 2D show O 1s (FIG. 2C) and P 2p (FIG. 2D) XPS spectra of assembled Ag NPs, before and after being biased. The line in FIG. 2C is the sum of the two fitted peaks (P═O and P—O—Ag). The arrows in FIGS. 2C and 2D indicate spectral changes after bias is applied. All electrochemical tests were conducted in 0.1 M KHCO₃ at 1 atm CO₂ in an aqueous H-cell configuration.

FIGS. 3A-3F show the results of experiments on the stable ligand layer of the NOLI and its reversible physisorption. FIG. 3A shows CV of Ag-NOLI after the first linear sweep voltammetry of assembled Ag NPs that led to collective dissociation of ligands. FIG. 3B shows multiple CV scans of Ag-NOLI. FIG. 3C shows infrared spectra of Ag-NOLI. FIGS. 3D and 3E show CO selectivity (FIG. 3D) and specific current density (FIG. 3E) of Ag-NOLI, Ag foil and Ag particles after the NOLI was removed from Ag-NOLI, at −0.68 V versus RHE. FIG. 3F shows ligand density of Ag-NOLI estimated from XPS throughout CO₂ electrolysis. All electrochemical tests were conducted in 0.1 M KHCO₃ at 1 atm CO₂ in an aqueous H-cell configuration. Error bars in FIGS. 3D-3F are one standard deviation of at least three independent measurements.

FIGS. 4A-4D show the results of experiments on the pseudocapacitive behaviour of the NOLI. FIGS. 4A and 4B show Bode and Nyquist plots of Ag-NOLI where the impedance (Z) was measured at −0.68 V versus RHE. Inset in FIG. 4B shows the equivalent circuit diagram of Ag-NOLI composed of solution resistance (Rₛ), double layer capacitance (C_{dl}), charge transfer resistance (R_{ct}), pseudocapacitance (C_{pseudo}) and charger transfer resistance for pseudocapacitance (R_{pseudo}) that was used to fit the experimental data for both FIGS. 4A and 4B. FIG. 4C shows specific capacitance measured for Ag-NOLI, Ag foil, and Ag particles after the NOLI was removed from Ag-NOLI. Real surface areas are estimated from Pb UPD. Error bars are one standard deviation of at least three independent measurements. FIG. 4D shows CV of Ag-NOLI and Ag particles after the NOLI was removed from Ag-NOLI. The shaded area is associated with the pseudocapacitive charge stored at the NOLI that is lost when the NOLI was removed.

FIGS. 5A-5C show the results of experiments on the cation association at the NOLI. FIG. 5A shows a schematic illustrating the desolvated cation insertion/adsorption at the NOLI. FIG. 5B shows XANES at the potassium K edge measured for Ag-NOLI, Ag foil and carbon paper. FIG. 5C shows the radial distribution function of O_{water} from K⁺ for the two different structures modeled. r, radius.

FIGS. 6A and 6B show the results of experiments on the catalytic mechanism of the NOLI. FIG. 6A shows the ΔG of b-CO₂^{δ-}, the first-principles calculated free-energy difference from CO₂ physisorbed (linear) to CO₂ chemisorbed (bent) for the two different structures modeled. It is postulated that a CO₂ molecule first physisorbs to transition to a chemisorbed CO₂. The values are the average of five different solvent fluctuations considered for the explicit solvent model used. Insets illustrate the NOLI and a bare Ag surface with CO₂ chemisorbed under bias. The shaded region around K⁺ of Ag-NOLI is to highlight the intimate electrostatic interactions between the chemisorbed CO₂, Ag atom (negatively charged) and unshielded K⁺. FIG. 6B shows the CO selectivity of Ag-NOLI and Ag foil tested under various concentrations of KHCO₃ at −0.68 V (left) and 0.1 M LiHCO₃ at −0.94 V (right). The dashed gray line indicates the maximum CO selectivity of Ag foil obtained using 0.1 M LiHCO₃ at −1.16 V. All CO selectivity values were measured in an aqueous H-cell configuration.

FIGS. 7A-7E show the results of experiments on the Au-NOLI and Pd-NOLI for selective CO₂ electrocatalysis in an H-cell configuration, and catalytic performance of Ag-NOLI in a GDE configuration. FIG. 7A shows the CO selectivity of Au-NOLI in CsHCO₃ at 1 atm CO₂, showing a minimal onset potential close to the theoretical value for CO production and high selectivity at low overpotentials. Dashed line indicates the standard reduction potential (E⁰) of CO₂ to CO. FIG. 7B shows the specific CO activity of Au-NOLI and Au foil in 0.5 M CsHCO₃ at 1 atm CO₂. FIG. 7C shows the electrocatalytic selectivity of Pd-NOLI in 0.5 M KHCO₃ at 1 atm CO₂. Electrochemical tests of Au-NOLI and Pd-NOLI presented in FIGS. 7A-7C were conducted in an aqueous H-cell environment (inset in FIG. 7A). FIGS. 7D-7F show the catalytic performance comparison between Ag-NOLI and commercial Ag NPs in a GDE configuration: CO selectivity at various total current densities (FIG. 7D); CO current density (j_{CO}) and selectivity (FIG. 7E); and CO activity per Ag loaded (Ag⁻¹_{Ag}) as a function of applied potentials (FIG. 7F). Tests in a GDE configuration were conducted in 1 M KHCO₃ at 1 atm CO₂, as indicated by the inset in FIG. 7D.

### DETAILED DESCRIPTION

Reference will now be made in detail to some specific examples of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims.

In the following description, numerous specific details are set forth in order to provide a thorough understanding of the present invention. Particular example embodiments of the present invention may be implemented without some or all of these specific details. In other instances, well known process operations have not been described in detail in order not to unnecessarily obscure the present invention.

Various techniques and mechanisms of the present invention will sometimes be described in singular form for clarity. However, it should be noted that some embodiments include multiple iterations of a technique or multiple instantiations of a mechanism unless noted otherwise.

The terms “about” or “approximate” and the like are synonymous and are used to indicate that the value modified by the term has an understood range associated with it, where the range can be ±20%, ±15%, ±10%, ±5%, or ±1%. The terms “substantially” and the like are used to indicate that a value is close to a targeted value, where close can mean, for example, the value is within 80% of the targeted value, within 85% of the targeted value, within 90% of the targeted value, within 95% of the targeted value, or within 99% of the targeted value.

Described herein is a composite catalyst that includes metal nanoparticles surrounded by a layer of organic ligands. The ligand layer, however, is not attached to the nanoparticle surface. Instead, the ligand layer floats immediately above the nanoparticle surface under negative bias, with the ligands orderly structured so that their interactions with the nanoparticle surface enable the entire ligand layer to be stable. There is expected to be no attractive interactions between the ligand layer and the metal surface, as both are negatively charged under negative bias. This, however, draws positively charged cations into the interlayer. The stability of the ligand layer results from the strong intermolecular interactions between the ligands.

Pseudocapacitive behavior is observed at the interlayer between the nanoparticle surface and the ligand layer. This pseudocapacitive interlayer can serve as a catalytic pocket for selective CO₂-to-CO electroconversion. We term this pseudocapacitive interlayer the nanoparticle/ordered-ligand interlayer (NOLI). Depending on the metal used, the composite catalyst is termed as M-NOLI, where M indicates the metal element of the nanoparticles (e.g. Ag-NOLI).

Considering the use of surface-bound ligands for nanoparticle formation, it is challenging to create a ligand layer surrounding nanoparticles in a detached form. To create such structure, colloidal nanoparticles were used as precursors and an electrical bias was used to induce their fusion. To create M-NOLI, metal (M) nanoparticles were colloidally synthesized with surface ligands and were densely assembled on a support. Upon application of a bias, originally surface-bound ligands collectively dissociated from the surface with concomitant nanoparticle coalescence at the core. However, due to the strong intermolecular interactions between large numbers of ligands induced by nanoparticle assembly, the ligand layer maintained its structural integrity in a detached form and remained in the vicinity of the nanoparticle surface. The ligands within the layer behave in a collective motion; the entire layer can respond dynamically to application of biases by adsorbing to and desorbing from the nanoparticle surface repeatedly.

Under a negative bias, hydrated cations in an aqueous electrolyte solution (e.g., K⁺ in 0.1 M KHCO₃) were drawn into the interlayer between the nanoparticle surface and the ligand layer, being removed of their water molecules in the surroundings that form a hydration shell. This insertion of dehydrated cations gives the interlayer pseudocapacitive characteristics with high specific capacitance compared to typical metal surfaces (i.e., above six-fold enhancements).

For example, Ag-NOLI showed a specific capacitance of 221.7 uF/cm² at −0.68 V vs. RHE while polycrystalline Ag foil exhibited only 34.6 uF/cm². The dehydrated cations interposed in this interlayer stabilize adsorbed CO₂ molecules through strong electrostatic interaction, facilitating CO₂ electroreduction. In contrast, for a typical metal surface, cations at the electrochemical interface are hydrated, resulting in a weak interaction with CO₂ molecules. As a result, Ag-NOLI in a H-cell type electrochemical cell showed significant enhancement in production rate of CO compared to a Ag foil catalyst (e.g., current density per specific surface area of 1.14 mA/cm² and 0.04 mA/cm², respectively at −0.68 V vs. reversible hydrogen electrode), and also in CO selectivity (e.g. 81.3% and 9.1%, respectively). Further, as the interlayer is protected from external conditions by the surrounding layer of ligands, M-NOLI catalysts retain their catalytic performance in various aqueous electrolyte environments. For example, when bicarbonate electrolyte is used (e.g., KHCO₃), the CO selectivity of Ag-NOLI is minimally affected by the concentration of bicarbonate that otherwise can have negative effects in other catalyst structures.

The electrocatalyst design can be applied to various metal particles (e.g. Ag, Au, and Pd). For example, Au-NOLI achieved 98.5% CO selectively at −0.36 V vs. RHE in 0.1 M CsHCO₃. Pd-NOLI attained 96.9% at −0.55 V vs. RHE in 0.5 M KHCO₃. The composite catalyst achieved superior CO selectivity at much lower overpotentials (i.e., lower energy input) compared to previously developed catalysts for CO₂-to-CO electroreduction. Further, the composite catalyst exhibited stable long-term catalytic performance. For example, Au-NOLI maintains nearly unit selectivity for 8 hours (about a 3% decrease in selectivity from ˜99% over 8 hours).

M-NOLI catalysts also function well in high production rate conditions. When M-NOLI catalysts are translated to a gas diffusion electrode (GDE) configuration where high mass transport of CO₂ molecules allows industrially-relevant electrolysis rates, the catalysts retain nearly unit CO selectivity at high current densities in neutral media. For example, Ag-NOLI achieved 98.1% CO selectivity at 400 mA/cm² in 1 M KHCO₃ while its mass activity (i.e., current density per catalyst mass loaded) reached 2921 A/g. In contrast, previously reported Ag based catalysts generally show 80-95% CO selectivity at current densities lower than 200 mA/cm², and mass activities usually lower than 500 A/g in neutral media.

One advantage of the catalyst composites described here for CO₂ electroconversion is the nearly unit selectivity (˜99%) towards CO achieved at much lower overpotentials (i.e., lower energy input) compared to other existing technologies (e.g., electrocatalyst systems). In addition, the catalyst composites have high selectivity at high current outputs (i.e., at sub A/cm² levels). Therefore, not only the energy input needed to drive CO2 electrolysis can be lowered, but the costs for product separation is minimal, which is often a problem for the application of a catalytic process.

For example, Ag-NOLI in a gas diffusion electrode configuration shows as much as 0.5 V reduction in potential applied. As overall cell voltage is expected to be ˜4 V at 200 mA/cm², an approximately 12% improvement in energy efficiency can be achieved. Further, the invention minimizes use of metals as a catalyst from its substantially enhanced mass activity (i.e., current density per catalyst mass loaded, A/g metal). Therefore, a lower amount of catalyst material (i.e., less metal mass loading) is needed to attain target rate outputs compared to conventional electrocatalysts, reducing the cost of materials and the overall system as a whole.

In some embodiments, a NOLI structure comprises an assembly and a layer of ligands disposed on a surface of the assembly. The assembly comprises a plurality of metal nanoparticles. The metal nanoparticles of the plurality of metal nanoparticles in the assembly are proximate one another. The layer of ligands is operable to detach from the surface of the assembly but to remain proximate the surface of the assembly when the assembly is disposed in an electrolyte and a negative bias is applied to the assembly. An interlayer forms between the assembly and the layer of ligands, with the interlayer comprising desolvated cations from the electrolyte. In some embodiments, the assembly is disposed on a substrate.

In some embodiments, ligands of the layer of ligands comprise anionic ligands. In some embodiments, ligands of the layer of ligands comprise anionic ligands, and the anionic ligands include a species selected from a group consisting of phosphonic acid, boronic acid, sulfonic acid, carboxylic acid, oleic acid, and thiol. In some embodiments, ligands of the layer of ligands are selected from a group consisting of Octadecylphosphonic acid, Tetradecylphosphonic acid, Dodecylphosphonic acid, Decylphosphonic acid, Tetradecylboronic acid, Decylboronic acid, Sodium octadecyl sulfate, Sodium hexadecyl sulfate, Sodium tetradecyl sulfate, Sodium dodecyl sulfate, Sodium decyl sulfate, Octadecanoic acid, Hexadecanoic acid, Tetradecanoic acid, Dodecanoic acid, Decanoic acid, Oleic acid, Octadecanethiol, Hexadecanethiol, Tetradecanethiol, Dodecanethiol, and Decanethiol.

In some embodiments, the layer of ligands is about 1 nanometer or less from the surface of the assembly. In some embodiments, the desolvated cations are selected from a group consisting of potassium cations, lithium cations, sodium cations, rubidium cations, and cesium cations.

In some embodiments, the electrolyte is selected from a group consisting of potassium bicarbonate, lithium bicarbonate, sodium bicarbonate, rubidium bicarbonate, and cesium bicarbonate. In some embodiments, the electrolyte is selected from a group consisting of a bicarbonate, a carbonate, a hydroxide, a chloride, a phosphate, a biphospate, a perchlorate, a sulfate, and a nitrate. In some embodiments, the electrolyte is selected from a group consisting of KHCO₃, K₂CO₃, KOH, KCl K₂HPO₄, KH₂PO₄, KClO₄, K₂SO₄, and KNO₃.

In some embodiments, a metal of the plurality of metal nanoparticles is selected from a group consisting of silver, gold, palladium, copper, zinc, indium, tin, lead, bismuth, and bimetallic alloys thereof. In some embodiments, the plurality of metal nanoparticles in the assembly is about 5 to 3000 nanoparticles. In some embodiments, the assembly has dimensions of about 10 nanometers to about 100 nanometers after the negative bias is applied to the assembly. In some embodiments, metal nanoparticles of the plurality of metal nanoparticles have dimensions of about 2 nanometers to 20 nanometers.

In some embodiments, the assembly is disposed on a substrate, and a loading of the plurality of metal nanoparticles on the substrate is about 1.4×10\hat{ }11 nanoparticles/cm² to 1.4×10\hat{ }13 nanoparticles/cm². In some embodiments, the assembly is disposed on a substrate, and the substrate comprises an electrically conductive substrate. In some embodiments, the assembly is disposed on a substrate, and the substrate is selected from a group consisting of a sheet of carbon paper, glassy carbon, a graphite plate, a graphite felt, and a metal (e.g., titanium mesh or a stainless steel mesh). In some embodiments, the assembly is disposed on a substrate, and the structure comprises an electrode.

In some embodiments, the layer of ligands comprises an ordered layer of ligands. In some embodiments, an ordered layer of ligands has a monolayer structure. In some embodiments, an ordered layer of ligands has a bilayer structure. In some embodiments, an ordered layer of ligands has structure that is a mixture of a monolayer structure and a bilayer structure. In some embodiments, the interlayer comprises a pseudocapacitive interlayer. In some embodiments, the interlayer serves as a catalyst in carbon dioxide conversion to a product selected from a group consisting of carbon monoxide, formate, methane, ethane, ethylene, acetate, ethanol, n-propanol, acetaldehyde, allyl alcohol, glycolaldehyde, and acetone.

In some embodiments, a method of fabricating a NOLI structure comprises fabricating a plurality of metal nanoparticles. Ligands are chemisorbed to a surfaces of metal nanoparticles of the plurality of metal nanoparticles. The plurality of metal nanoparticles is deposited on a substrate at a metal nanoparticle density high enough such that an assembly of the metal nanoparticles is formed. The substrate is submersed in an electrolyte. A negative bias is applied to the substrate to dissociate ligands from a surface of the assembly and to insert cations from the electrolyte between the surface of the assembly and dissociated ligands. The dissociated ligands form a layer of ligands proximate the surface of the assembly.

In some embodiments, the plurality of metal nanoparticles is deposited on the substrate using with drop casting. In some embodiments, the negative bias is about −1.5 V vs. RHE or less, or about −1 V vs. RHE or less. In some embodiments, the negative bias breaks the chemical bonds of the chemisorption between the ligands and the surface of the assembly.

In some embodiments, a method of fabricating a NOLI structure comprises providing a substrate having a plurality of metal nanoparticles disposed thereon. The density of metal nanoparticles of the plurality of metal nanoparticles is high enough such that an assembly of the metal nanoparticles is formed. Ligands and ligands are chemisorbed to surfaces of the metal nanoparticles. The substrate is submersed in an electrolyte. A negative bias is applied to the substrate to dissociate ligands from a surface of the assembly and to insert cations from the electrolyte between the surface of the assembly and dissociated ligands. The dissociated ligands form a layer of ligands proximate the surface of the assembly.

In some embodiments, the negative bias is removed, and the layer of ligands is thereafter physisorbed to the surface of the assembly. In some embodiments, the layer of ligands is reversibly dissociated from and physisorbed to the surface of the assembly by applying and removing the negative bias.

Further details regarding the NOLI structures, fabrication of NOLI structures, and characterization of different NOLI structures are set forth in the examples below.

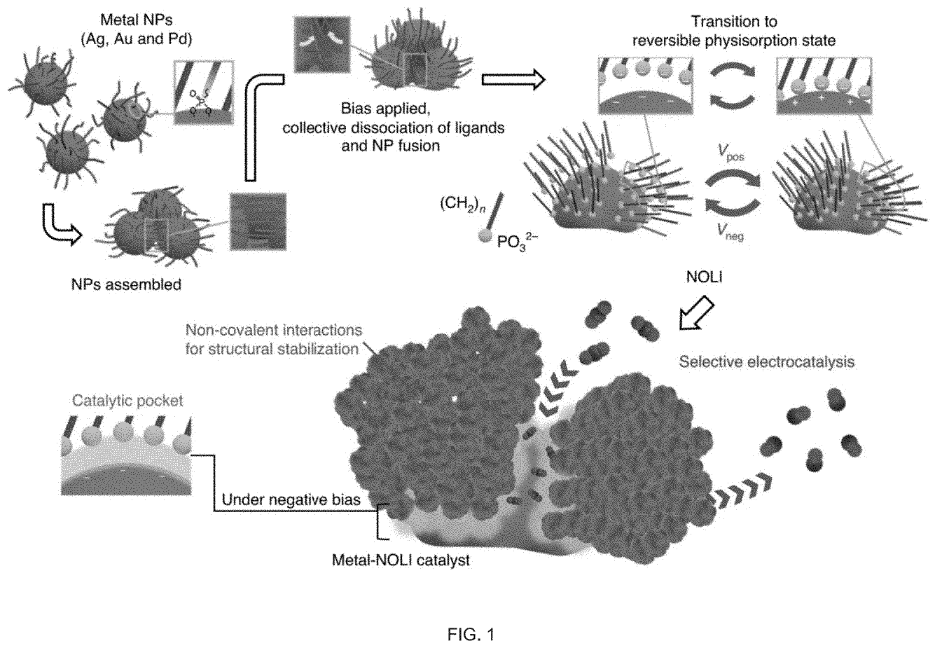

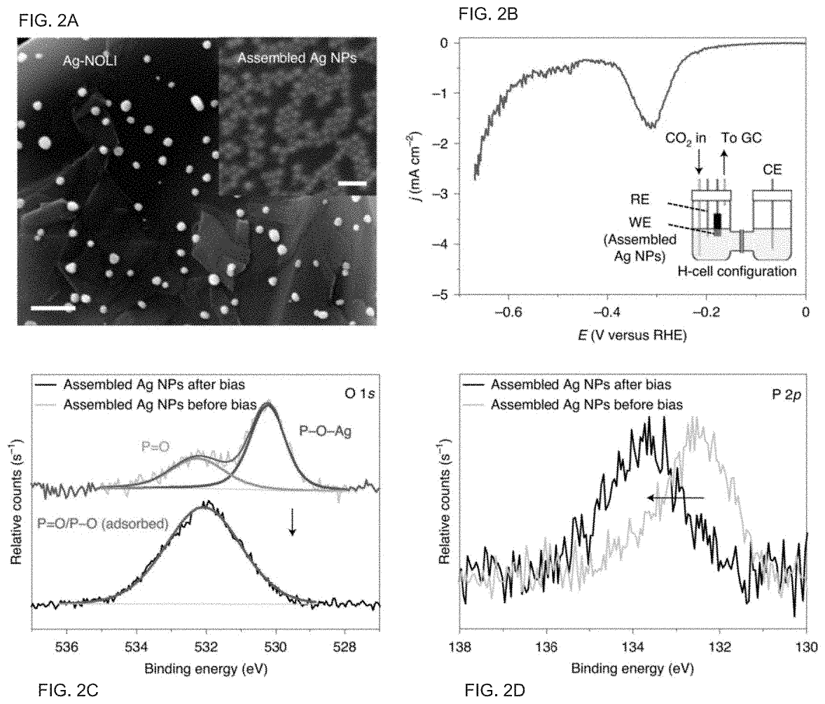

Formation and structure of the NOLI. Ligand-capped colloidal metal NPs were used to form the NOLI (FIG. 1); for example, to create Ag-NOLI, Ag NPs synthesized with tetradecylphosphonic acid (TDPA) ligands were used as a precursor. X-ray photoelectron spectroscopy (XPS) showed that the phosphonate head group of the TDPA ligand binds to the Ag NP surface through two oxygen atoms in a bidentate mode (FIG. 1). To initiate Ag-NOLI formation, Ag NPs were assembled on a carbon paper support with the NPs interfacing each other in an array (FIG. 2A inset). In this configuration, a potential sweep resulted in a cathodic peak from the passage of reductive charge (FIG. 2B) owing to the dissociation of chemisorbed (that is, covalently bonded) surface ligands (hereafter, dissociation refers to reductive cleavage of covalent bonds and desorption refers to departure of adsorbed, that is physisorbed, ligands). The peak did not exist for Ag foil and is not an inherent characteristic of Ag. Its reductive charge (C) estimates all of the NP ligands to be dissociated. This is well characterized in the O 1s spectrum (FIG. 2C) after the potential sweep, showing the loss of P—O—Ag bonds and a transition to a physisorbed state for the phosphonate oxygens (P═O/P—O). Accordingly, the P 2p signal located at 132.4 eV, due to the formation of P—O—Ag bonds, shifts to 133.7 eV as a result of their cleavage (FIG. 2D). Also, as part of the process, the original Ag NPs fuse to result in larger particles at its core (FIG. 2A).

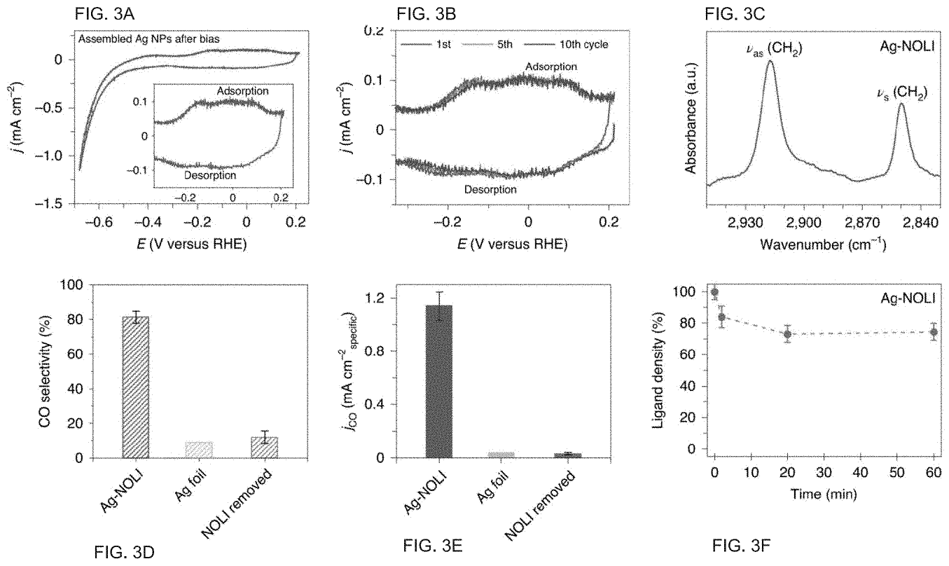

However, the ligands detached from the NP surface by the application of bias are never fully removed. A cyclic voltammetry (CV) scan after the first reductive sweep of assembled Ag NPs exhibited a reversible ad/desorption feature (FIG. 3A), which was again absent for Ag foil. We attribute this feature to the reversible adsorption of ligands on the Ag NPs (FIG. 1), similar to phosphate anion ad/desorption on a silver surface. A stable CV response during multiple scans (FIG. 3B) indicated that the desorbed ligands under negative biases remain in the vicinity of NP surfaces rather than being completely lost into the solution, a unique feature of the NOLI.

Furthermore, assembly of NPs is a precondition to this collective dissociation of ligands by the application of bias. When initially the Ag NPs are individually isolated on the carbon support, both the cathodic peak during the potential sweep and the reversible ad/desorption features of the dissociated ligands were not present. For the original NPs in an isolated configuration, the ligands remain covalently attached and do not transition to the reversible physisorption state, as will be discussed more in detail below. However, when the same amount of Ag NPs are assembled by loading them on a smaller geometric carbon support, the initial collective dissociation and reversible physisorption features reappear. Consequently, we find that the close assembly of NPs triggers the NOLI formation by allowing intimate interactions between ligand chains of a large number of NPs.

Not only is the collective behaviour of ligands responsible for their initial dissociation, but it should be critical for allowing the ligand layer to remain stable near the particle surface despite being at a desorbed state under negative biases. Among efforts to understand the structure of the ligand shell on metal NPs, one way is to probe the CH₂ stretching vibrations (νₐₛ and νₛ), where increased structural disorder results in a shift to higher wavenumbers. The infrared spectrum of the Ag-NOLI formed indicated a structurally ordered ligand layer (FIG. 3C), based on the CH₂ stretching frequencies (νₐₛ(CH₂), 2,917.4 cm⁻¹; νₛ(CH₂), 2,849.9 cm⁻¹) that align closely with those of TDPA crystals. The dense assembly of NPs (FIG. 2A inset) was expected to promote interactions between the ligand chains to allow this transition to a more ordered configuration, and this was further validated by sum frequency generation (SFG) vibrational spectroscopy. Therefore, the NOLI formation (FIG. 1) can be described as a collective dissociation of ligands from assemblies of NPs when electrically biased, leading to a structurally ordered ligand layer stabilized by the non-covalent interactions between dense alkyl chains with dynamic responses to biases.

Given the reversible ad/desorption of the ligand layer, an interlayer exists at negative biases between the NP surface and the desorbed ligand layer in its vicinity (FIG. 1). We find that this region can act as a catalytic pocket for promoting CO₂ conversion. Once the ligand layer desorbs at negative biases, an increase in currents due to electrochemical reduction of CO₂ can be observed (FIG. 3A). When a stationary bias was applied in a typical aqueous H-cell configuration, a stable current response was recorded and Ag-NOLI was able to promote selective CO formation (FIG. 3D), while no other liquid products were found. Specific activity of Ag-NOLI towards CO, taking into account its electrochemically accessible surface area, is approximately two orders of magnitude higher than that of the Ag foil (FIG. 3E). By contrast, a more typical arrangement of initially isolated Ag NPs results in only a minor increase in the CO₂ reduction activity, supporting the unique catalytic role of the NOLI structure. Moreover, the NP size and crystallites of Ag-NOLI are not responsible for the improvement observed. However, when the ligand layer is intentionally removed from Ag-NOLI, the CO selectivity and turnover drop to levels similar to those of Ag foil (FIG. 3D, 3E), strongly supporting the catalytic role of NOLI for the selective CO₂-to-CO transformation, which is further evidenced by its 97% CO selectivity.

Importantly, after the early loss of ligands that coincides with vast rearrangement of catalysts by NP coalescence and fusion (FIG. 2A), the ligand density (with respect to the NP surface area) remains relatively stable throughout electrolysis though at a desorbed state (FIG. 3F). Characterizations by CV and XPS indicated that the NOLI structure remains stable during its catalytic promotion for CO₂ conversion. By contrast, when Ag NPs are initially isolated, the ligands either remain covalently bonded or are entirely lost to the surrounding environment, both typical situations expected for ligand-capped NPs. Tracking the initially isolated configuration of Ag NPs throughout reduction showed a substantial portion being individually lost to the solution while the remaining ligands stay covalently attached in their original configuration. This increases the structural disorder of the remaining ligands during CO₂ electrolysis, contrary to the structurally ordered ligand layer observed from Ag-NOLI. In addition, the remaining ligand coverage is lower for the initially isolated NPs, despite the ligand layer in Ag-NOLI operating at a physically desorbed state (FIG. 3F).

Taking these results together, we conclude that the NOLI forms and operates under the strong interactions between ligand chains that are allowed by the close assembly of NPs, likely leading to starting configurations such as the interdigitation of ligands (FIGS. 1 and 3C). It is the strong intermolecular interaction that produces the collective dissociation of ligands during the NOLI formation while stabilizing the structure at a reversible physisorption state. By contrast, for the isolated NPs lacking such interaction, the NOLI does not form, and the ligands stay covalently attached. However, the remaining surface coverage is lower for the isolated NPs due to the absence of stabilizing interactions between ligands under reductive bias. All these observations highlight the unconventional structural state of the NOLI structure.

In addition, self-assembled monolayers of TDPA formed on an Ag foil were studied in the same manner. This sample also lacked the collective dissociation behaviour of ligands and the following reversibility in their adsorption. Instead, it featured a rapid individual ligand loss, even after the first bias sweep, with similar catalytic activity as observed from a bare Ag foil. Therefore, the strong intermolecular interactions between ligands are a prerequisite to the bias-induced transition to the NOLI structure that tends to be accessible by NP assembly.

Pseudocapacitive behaviour and catalytic effect of the NOLI. Despite the growing awareness of the role of the electrochemical interface and its constituents for catalytic reactions, tethered-molecule approaches generally do not evaluate the presence and effects of the constituents, limiting our understanding and manipulation of electrochemical reactions at heterogeneous surfaces. In order to probe the interplay between the NOLI and electrochemical environment, several techniques were employed.

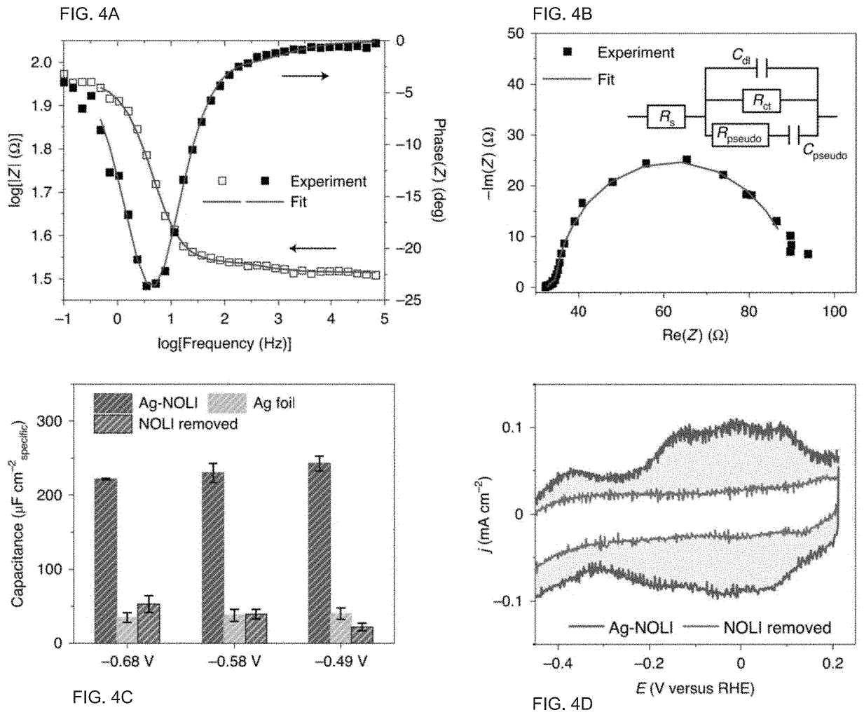

First, electrochemical impedance spectroscopy (EIS) was used at the catalytically relevant conditions. FIG. 4A shows the Bode plot of Ag-NOLI at −0.68 V versus reversible hydrogen electrode (RHE). By comparing with the simulated Bode plots of a typical heterogeneous electrocatalytic interface, we observed that Ag-NOLI exhibits not only a low charge transfer resistance for CO₂ conversion, but a surprisingly high capacitance. Furthermore, in the Nyquist plots (FIG. 4B), we found a characteristic feature (a smaller semicircle in the high frequency region) indicative of a pseudocapacitive interface in parallel with charge transfer resistance and double layer capacitance, which was absent in the other systems.

With the EIS data at various potentials fitted (equivalent circuit shown in FIG. 4B), pseudocapacitance values associated with Ag-NOLI could be extracted. The specific capacitance of Ag-NOLI (FIG. 4C) was estimated to be about six times higher than that of the Ag foil, which is at typical values (30-40 μF cm⁻²) for metals in alkali-metal-based electrolytes. When the NOLI was removed, these values decreased back to levels similar to Ag foil, together with the loss of the pseudocapacitive characteristic, as observed from EIS (FIG. 4C). Accordingly, not only did the reversible ad/desorption features of the ligand layer disappear, but there was a notable collapse of the capacitive charge stored after the NOLI removal (FIG. 4D). Therefore, we found that Ag-NOLI exhibits pseudocapacitance, which has been observed for metal derivatives (that is, transition metal oxides, and two-dimensional transition metal dichalcogenides, carbides and nitrides) but not yet for pure metals. The high specific capacitance of Ag-NOLI is also very unusual considering the general effect of ligands attached to metal surfaces that should lead to the reduction of specific capacitance instead. Furthermore, its unique presence should have an influence on promoting the electrocatalytic conversion of CO₂.

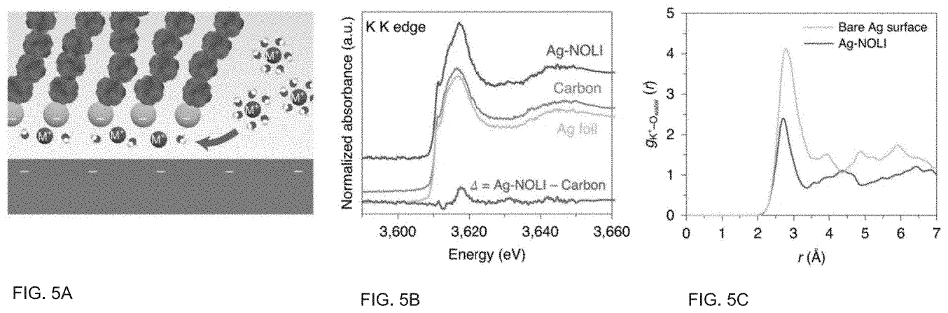

Considering the pseudocapacitive behaviour of metal derivatives, we expected the origin of pseudocapacitance in the NOLI structure to be cation insertion/adsorption at the interlayer region between the NP surface and ligand layer (FIG. 5A). The NOLI represents a heterostructured metal-organic interlayer for ion/charge storage. The presence of associated dehydrated cations can be probed by X-ray absorption near edge structure (XANES), since the potassium K edge is sensitive to its surrounding coordination environment. Potassium ions hydrated in aqueous solutions exhibit a symmetric single absorption peak (3,616.5 eV), in contrast to potassium salts that feature a white line splitting caused by the asymmetry of the surrounding electric field due to pairing of the counter anions. K XANES was conducted by having electrodes, just before data acquisition, emersed under constant bias and tightly sealed in a plastic pouch to prevent drying.

Potassium XANES of Ag-NOLI exhibited features distinct from the spectra of the Ag foil and the carbon paper used as a support, both of which present hydrated K⁺ (FIG. 5B). Specifically, a main absorption peak at 3,617.8 eV with a shoulder at 3,614.0 eV was observed, indicating the presence of dehydrated K⁺, as can be noted from the difference (Δ) in the spectra of Ag-NOLI and the carbon support. By contrast, the tethered-ligand configuration also exhibited hydrated K⁺, making such features unique to the interface of Ag-NOLI. Ab initio molecular dynamics (MD) simulation of an Ag surface with a floating ligand layer, mimicking Ag-NOLI, further confirmed the presence of dehydrated K⁺. In contrast to a K⁺ ion at the outer Helmholtz plane of a bare silver surface, the radial distribution function of water-oxygen atoms around K⁺ exhibited a substantial reduction, mainly at the first peak around 2.8 Å representing the first layer of water molecules (FIG. 5C). Primarily, the interaction of K⁺ to the anionic phosphonate head group of the ligands drives its dehydration in the NOLI structure. In addition, K 2p XPS measured from emersed electrodes during CO₂ electrolysis indicated a larger presence of K⁺ post-electrolysis that should be associated with the NOLI. Therefore, we posit that the NOLI encompasses dehydrated cations at the interlayer by its interactions with the electrochemical environment.

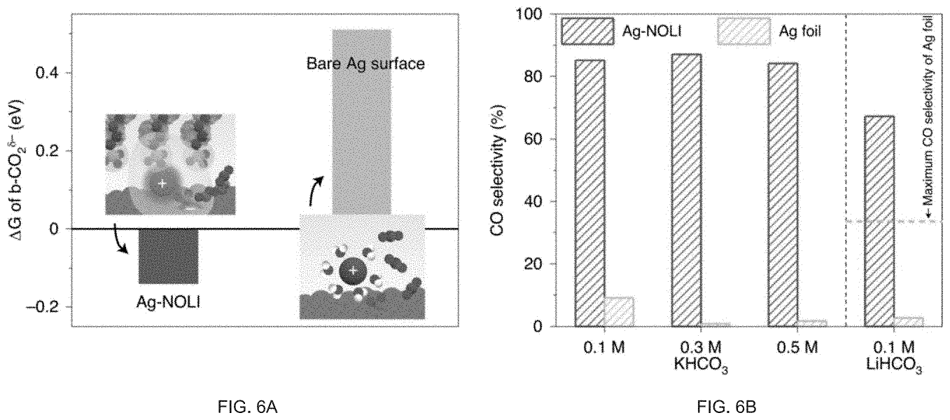

The structural details of Ag-NOLI present a reaction center in which the vicinal phosphonate ligand anchors the dehydrated K⁺ ion close to the surface of a metal atom. This configuration is suited for stabilizing molecules through intimate electrostatic interactions by both ends of the negatively charged metal site and unshielded K⁺. The polarization of a non-polar CO₂ with an electron transfer to form a *CO₂⁻ (the asterisk indicates adsorbed species) is often considered the energetically demanding step. Through first-principles free-energy calculations with density functional theory, by using the explicit solvent models, we found that the specific configuration for the NOLI can facilitate the bending of the adsorbed CO₂ molecule (that is, b-CO₂^{δ-}, chemisorbed CO₂; FIG. 6A). Furthermore, an entire layer of vicinal phosphonates should also mean a higher population of such cations, adding to the effect as an extended surface of substantially enhanced near-field strength that should promote catalytic turnover.

The NOLI contains interesting aspects resembling an enzyme. Not only is the reaction center composed of multiple components, but they are pre-organized or pre-positioned with the right elements so that a strong electrostatic interaction stabilizes a key intermediate state, a previously established mechanism for enzymatic catalysis. The specific site arrangement disfavors undesired catalytic pathways, for example, hydrogen evolution. Furthermore, the entire structure is stabilized by the interactions of ligand chains, similar to the amino acid side chains of proteins that hold their structure. In addition, the NOLI keeps a constant active-site environment by minimizing the impact from external chemical conditions. Ag-NOLI retains its high CO selectivity (FIG. 6B), despite an increase in the bicarbonate concentration, which usually raises H₂ selectivity.

From an interfacial perspective, the NOLI-based catalysis demonstrates manipulation of near-surface regions of the electrochemical double layer by a metal-organic heterostructure. With recent focus on the fundamental roles of electrolyte ions and solvents for electrochemical reactions, it is important to develop catalyst materials that can modulate the electrochemical interface. For instance, despite their suggested role in stabilizing CO₂ reduction intermediates, hydrated cations at the interface pose limited effects as observed from the catalytic activity of polycrystalline Ag foil (FIGS. 3D and 3E). Consequently, smaller alkali cations (for example, Li⁺) with large hydration energy and a tightly bound solvation shell exhibit negligible effects leading to worse catalytic behaviour. However, such cations recover their utility when dehydrated and organized at the NOLI's reaction center. For example, Ag-NOLI in 0.1 M LiHCO₃ is able to attain near 70% CO selectivity in contrast to the 3% obtained from the Ag foil (FIG. 6B), on which even further bias to negative potentials only allows ˜35% at maximum.

Modularity of NOLI-based catalysts and application to GDE systems. The formation of the NOLI is not exclusive to the TDPA ligand. Anionic ligands with a long hydrocarbon chain, in general, can potentially be used. For instance, oleic-acid-capped Ag NPs can also serve as a precursor to form Ag-NOLI with an oleic-acid ligand layer. Furthermore, the NOLI's behaviour suggests that the properties of the NOLI can be tailored by its components such as the ligand used.

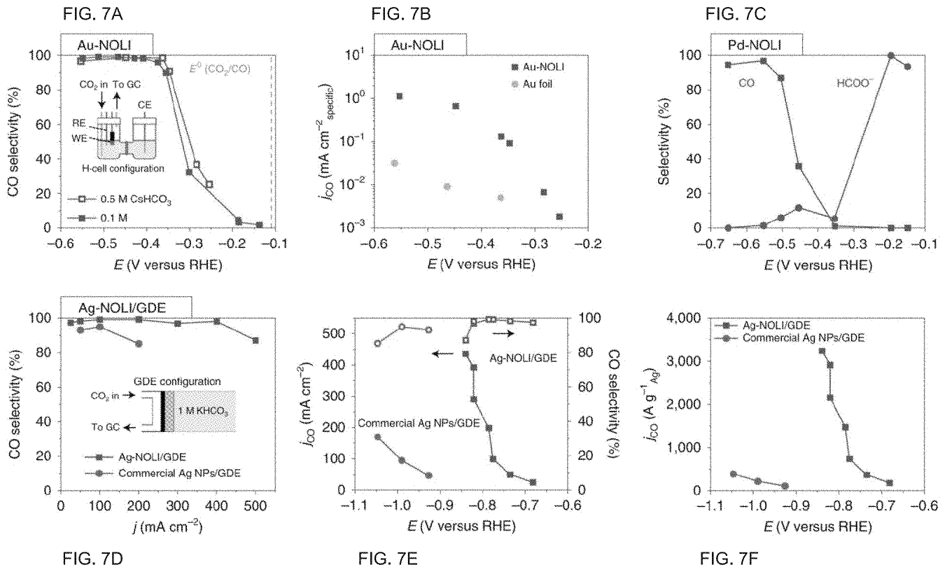

We also explored the translation of NOLI to other noble-metal-based NPs (Au- and Pd-NOLI). Gold and palladium are known for their favorable characteristics in CO₂ conversion. Au-NOLI based on Au NPs with identical ligand chemistry attained highly selective CO formation (98.9%) with its structure confirmed similarly as with Ag-NOLI. In addition, Au-NOLI achieved high selectivity in various cationic environments (that is, Li⁺, K⁺ and Cs⁺); however, interestingly, the potential at which the system operates tends to be cation-dependent. Small cations such as Li⁺ require more-negative biases to be introduced into the NOLI, presumably due to their larger hydration energies and thus tightly bound solvation shells. Meanwhile, Au-NOLI in a Cs⁺-based environment showed a minimal onset overpotential (27 mV), furthermore approaching nearly unit selectivity (98.5%) at −0.36 V versus RHE with little effect from the bulk electrolyte concentration (FIG. 7A). Specific activity was enhanced around two orders of magnitude as well (FIG. 7B). Moreover, the catalyst can operate in the long term, and removal of the NOLI results in a substantial drop in CO selectivity. The superior selectivity of Au-NOLI clearly outcompetes the previous tethered-ligand approaches and is one of the highest among the state-of-the-art electrocatalysts for CO₂-to-CO conversion in aqueous H-cell environments.

Similarly, Pd-NOLI also enabled selective conversion of CO₂ to formate or CO, depending on the applied potential range (FIG. 7C). Its CO selectivity at low overpotentials (for example, 96.9% at −0.55 V) compared favorably with previously reported Pd-based catalysts. Intrigued by the CO₂-to-CO enhancement by the NOLI, we sought to explore its potential for multicarbon (C₂₊) formation. TDPA-capped Cu NPs were preconfigured in the same manner and tested for CO₂ electrolysis. Cu-NOLI exhibited a substantially improved C₂₊ selectivity compared to the isolated Cu NPs and Cu foil. However, it has been shown that copper exhibits a complex restructuring process under electrochemical conditions in contrast to the noble metals studied here, which simply experience fusion and crystal growth. Therefore, we suspect both the NOLI and the restructured copper surfaces at the core to have contributed to the C—C formation, and their exact mechanism remains to be understood. Overall, through modular design of a metal-NOLI catalyst, a variety of highly selective CO₂ conversions can be achieved.

In addition, to gauge the benefits of NOLI-based catalysts for high-rate CO₂ electroconversion, we translated the Ag-NOLI catalyst to a gas-diffusion environment (GDE; that is, three-phase configuration). Ag-based catalysts in GDE systems under neutral electrolyte conditions have shown limited development, in contrast to the concentrated alkaline conditions whose electrolyte-derived advantage often surpasses the intrinsic benefits of catalysts. We demonstrated that Ag-NOLI in a neutral environment can deliver substantial improvements.

In order to allow a dense assembly of Ag NPs similar to that formed on the carbon paper support used in the H-cell configuration, Ag NPs were drop-casted on the carbon paper side of a GDE, instead of the microporous layer side typically used for catalyst loading. It was also the Ag-NP-loaded carbon paper side that faces the electrolyte, despite the disadvantage shown with tests using commercial Ag NPs on that particular side. Ag-NOLI in a flow-by GDE configuration maintained nearly unit CO selectivity up to very high current densities (for example, 98.1% at 400 mA cm⁻² in 1 M KHCO₃) under neutral electrolyte conditions (FIG. 7D). By contrast, previously reported Ag-based catalysts have been demonstrated at only <200 mA cm⁻² with CO selectivity in the range of 80-95% under similar conditions (FIG. 7D). Furthermore, the high-rate CO₂-to-CO conversions are achieved by Ag-NOLI at applied potentials that are as much as 500 mV less than those in previous reports (FIG. 7E).

After CO₂ electrolysis in a GDE configuration, a reversible ad/desorption feature of the ligands in CV scans and a transition of the XPS spectra were observed, confirming the NOLI structure present during catalysis. Furthermore, Ag-NOLI showed stable performance during extended periods of high-rate CO₂ electrolysis. The improvements are made possible by the high intrinsic activity of Ag-NOLI, which can be indirectly gauged by the CO activity measured per catalyst loaded, since estimation of the active catalyst area in an operating GDE environment is difficult (FIG. 7F). More than an order of magnitude enhancement in activity at considerably reduced potentials supports that Ag-NOLI delivers distinctly high intrinsic activity.

Furthermore, given that cations are essential constituents of the NOLI, other electrolyser designs with freely available cations would also be viable platforms for the NOLI-based catalysts (for example, a membrane electrode assembly with a solid-supported electrolyte layer), besides the GDE configuration demonstrated here. Overall, the demonstration of Ag-NOLI translated to a gas-diffusion environment holds great promise for practical applications as well.

Synthesis of silver NPs. Ten millilitres of trioctylamine in a three-neck flask was purged with nitrogen gas at 130° C. for 30 min to remove any moisture in the solvent, and cooled to room temperature, after which 0.50 mmol of silver(i) acetate and 0.25 mmol of TDPA were added. The solution was heated with stirring to 130° C. for 1 h under a N₂ atmosphere. During the reaction, the color of the solution changed from murky white to dark brown. After the reaction, the heating mantle was removed, and the solution was cooled to 50° C., at which it was extracted into a centrifuge tube and ethanol (35 ml) was added. The solution mixture was centrifuged at 6,000 r.p.m. for 15 min. NPs were redispersed in hexane (10 ml), and acetone was added dropwise until the solution became turbid (˜10 ml) as a post size selection process. After centrifugation at 12,000 r.p.m. for 10 min, NPs were redispersed in hexane.

For the synthesis of oleic-acid-capped silver NPs, a previously reported procedure was modified. First, 0.60 mmol of silver(i) trifluoroacetate and 3.6 mmol of oleic acid were added into 10 ml of isoamyl ether in a three-neck flask. The solution was heated with stirring to 160° C. for 1 h under a N₂ atmosphere, and was cooled to 50° C. Similar washing and post size selection processes were subsequently conducted.

Synthesis of gold NPs. The same ligand, TDPA, used for the synthesis of Ag NPs was used for Au NPs. First, 10 ml of 1-octadecene was purged with N₂ at 130° C. for 30 min, after which it was cooled to room temperature. Then 0.10 mmol of gold(III) acetate and 0.40 mmol of TDPA were added, and the mixture in a three-neck flask was ultrasonicated for 10 min. After the dissolution of the precursors, the temperature of the solution was increased to 105° C. and kept there for 20 min with stirring under a N₂ atmosphere. The solution color changed from bright brown to dark burgundy during the synthesis. After cooling to room temperature and transferring to a centrifuge tube, 30 ml of acetone was added, and the solution was centrifuged at 12,000 r.p.m. for 10 min. NPs were redispersed in 5 ml of hexane and centrifuged at 12,000 r.p.m. for 10 min without adding any other solvent. Only the supernatant was transferred to another centrifuge tube. Next, 15 ml of acetone was added, and the solution was centrifuged at 12,000 r.p.m. for 10 min. NPs were redispersed in hexane. To prepare an Au-NP-based electrode (Au-NOLI), 50.2 μg of NPs (by the mass of gold) were deposited on the carbon paper.

Synthesis of palladium NPs. TDPA was also used for palladium NP synthesis. First, 10 ml of diphenyl ether was purged with N₂ at 130° C. for 30 min. After cooling the solvent to room temperature, 0.10 mmol of palladium(ii) acetate and 0.20 mmol of TDPA were added. The solution was heated to 130° C. for 30 min with stirring under a N₂ atmosphere. The color of the solution changed from bright brown to dark grey-brown during the synthesis. The solution was cooled to room temperature and put into two centrifuge tubes. Each centrifuge tube contained 5 ml of the reaction solution, and 40 ml of acetone was added to each tube. Centrifugation was carried out at 12,000 r.p.m. for 10 min, and the supernatant was decanted. NPs were redispersed in 5 ml of hexane and centrifuged without adding any other solvent at 12,000 r.p.m. for 10 min. Supernatant was transferred to another centrifuge tube. For washing the NPs, the NP solution was dried, and 5 ml of acetone was added. After rigorous ultrasonication, it was centrifuged at 12,000 r.p.m. for 10 min. Finally, NPs were redispersed in chloroform. To prepare a Pd-NP-based electrode (Pd-NOLI), 14.9 μg of NPs (by the mass of palladium) were deposited on the carbon paper.

### Conclusion

The NOLI presents a unique role for ligands as part of a functional NP, resulting in a distinct class of material for electrocatalysis. The NOLI enables creation of a catalytic reaction center, in harmony with the electrochemical environment, which functions through close cooperation of multiple components, leading to efficient stabilization of key transition states and driving selective catalysis. From such a discovery, we anticipate NP catalyst design to expand in efforts to create enzymatic counterparts that may bring a range of catalytic reactions closer to the ideal. Furthermore, the unique ion interactions within the NOLI signify its potential use for various other applications such as energy and charge storage.

Further details regarding the embodiments described herein can be found in Kim, D., Yu, S., Zheng, F. et al. Selective CO₂ electrocatalysis at the pseudocapacitive nanoparticle/ordered-ligand interlayer. Nat Energy 5, 1032-1042 (2020), which is herein incorporated by reference.

In the foregoing specification, the invention has been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

What is claimed is:

1. A structure comprising:
an assembly comprising a plurality of metal nanoparticles, metal nanoparticles of the plurality of metal nanoparticles in the assembly being proximate one another; and
a layer of ligands disposed on a surface of the assembly, the layer of ligands operable to detach from the surface of the assembly but to remain proximate the surface of the assembly when the assembly is disposed in an electrolyte and a negative bias is applied to the assembly, an interlayer forming between the assembly and the layer of ligands, the interlayer comprising desolvated cations from the electrolyte.

2. The structure of claim 1, wherein ligands of the layer of ligands comprise anionic ligands.

3. The structure of claim 1, wherein ligands of the layer of ligands comprise anionic ligands, and wherein the anionic ligands include a species selected from a group consisting of phosphonic acid, boronic acid, sulfonic acid, carboxylic acid, oleic acid, and thiol.

4. The structure of claim 1, wherein ligands of the layer of ligands are selected from a group consisting of Octadecylphosphonic acid, Tetradecylphosphonic acid, Dodecylphosphonic acid, Decylphosphonic acid, Tetradecylboronic acid, Decylboronic acid, Sodium octadecyl sulfate, Sodium hexadecyl sulfate, Sodium tetradecyl sulfate, Sodium dodecyl sulfate, Sodium decyl sulfate, Octadecanoic acid, Hexadecanoic acid, Tetradecanoic acid, Dodecanoic acid, Decanoic acid, Oleic acid, Octadecanethiol, Hexadecanethiol, Tetradecanethiol, Dodecanethiol, and Decanethiol.

5. The structure of claim 1, wherein the layer of ligands is about 1 nanometer or less from the surface of the assembly.

6. The structure of claim 1, wherein the desolvated cations are selected from a group consisting of potassium cations, lithium cations, sodium cations, rubidium cations, and cesium cations.

7. The structure of claim 1, wherein the electrolyte is selected from a group consisting of potassium bicarbonate, lithium bicarbonate, sodium bicarbonate, rubidium bicarbonate, and cesium bicarbonate.

8. The structure of claim 1, wherein the electrolyte is selected from a group consisting of a bicarbonate, a carbonate, a hydroxide, a chloride, a phosphate, a biphospate, a perchlorate, a sulfate, and a nitrate.

9. The structure of claim 1, wherein the electrolyte is a selected from a group consisting of KHCO₃, K₂CO₃, KOH, KCl K₂HPO₄, KH₂PO₄, KClO₄, K₂SO₄, and KNO₃.

10. The structure of claim 1, wherein a metal of the plurality of metal nanoparticles is selected from a group consisting of silver, gold, palladium, copper, zinc, indium, tin, lead, bismuth, and bimetallic alloys thereof.

11. The structure of claim 1, wherein the plurality of metal nanoparticles in the assembly is about 5 to 3000 nanoparticles.

12. The structure of claim 1, wherein the assembly has dimensions of about 10 nanometers to about 100 nanometers after the negative bias is applied to the assembly.

13. The structure of claim 1, wherein the assembly is disposed on a substrate, and wherein a loading of the plurality of metal nanoparticles on the substrate is about 1.4×10\hat{ }11 nanoparticles/cm² to 1.4×10\hat{ }13 nanoparticles/cm².

14. The structure of claim 1, wherein metal nanoparticles of the plurality of metal nanoparticles have dimensions of about 2 nanometers to 20 nanometers.

15. The structure of claim 1, wherein the layer of ligands comprises an ordered layer of ligands.

16. The structure of claim 1, wherein the interlayer comprises a pseudocapacitive interlayer.

17. The structure of claim 1, wherein the assembly is disposed on a substrate, and wherein the substrate comprises an electrically conductive substrate.

18. The structure of claim 1, wherein the assembly is disposed on a substrate, and wherein the substrate is selected from a group consisting of a sheet of carbon paper, glassy carbon, a graphite plate, a graphite felt, and a metal (e.g., titanium mesh or a stainless steel mesh).

19. The structure of claim 1, wherein the interlayer serves as a catalyst in carbon dioxide conversion to a product selected from a group consisting of carbon monoxide, formate, methane, ethane, ethylene, acetate, ethanol, n-propanol, acetaldehyde, allyl alcohol, glycolaldehyde, and acetone.

20. The structure of claim 1, wherein the assembly is disposed on a substrate, and wherein the structure comprises an electrode.
